(19) United States
(12) Patent Application Publication
(10) Pub. No.: US 2024/0338246 A1
(43) Pub. Date: Oct. 10, 2024

(54) DYNAMIC FAN SPEED MANIPULATION TO INFLUENCE ALLOCATION OF COMPUTING RESOURCES

(71) Applicant: DELL PRODUCTS L.P., Round Rock, TX (US)

(72) Inventors: Kearson McNulty, Austin, TX (US); Suraj Varma, Portland, OR (US); Alok Pant, Austin, TX (US); Travis North, Cedar Park, TX (US)

(21) Appl. No.: 18/295,729

(22) Filed: Apr. 4, 2023

(51) Int. Cl. G06F 9/48; G06F 9/50

(52) U.S. Cl. CPC G06F 9/4881; G06F 9/5038

(57) ABSTRACT

An information handling system determines a fan speed value based on a current fan speed value and at least one factor, and transmits the fan speed value instead of the current fan speed value to an operating system scheduler. The system may also determine a fan acoustic level based on the fan speed value, and perform an action based on the fan acoustic level.

### FIELD OF THE DISCLOSURE

The present disclosure generally relates to information handling systems, and more particularly relates to dynamic fan speed manipulation to influence allocation of computing resources.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An information handling system determines a fan speed value based on a current fan speed value and other factors, and transmits the derived fan speed value instead of the current fan speed value to an operating system scheduler. The system may also determine a fan acoustic level based on the fan speed value, and perform an action based on the fan acoustic level.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram illustrating an information handling system according to an embodiment of the present disclosure;

FIG. 2 is a block diagram illustrating a system for dynamic manipulation of fan speed to influence the allocation of computing resources, according to an embodiment of the present disclosure; and

FIG. 3 is a flowchart illustrating a method for dynamic fan speed manipulation to influence the allocation of computing resources, according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

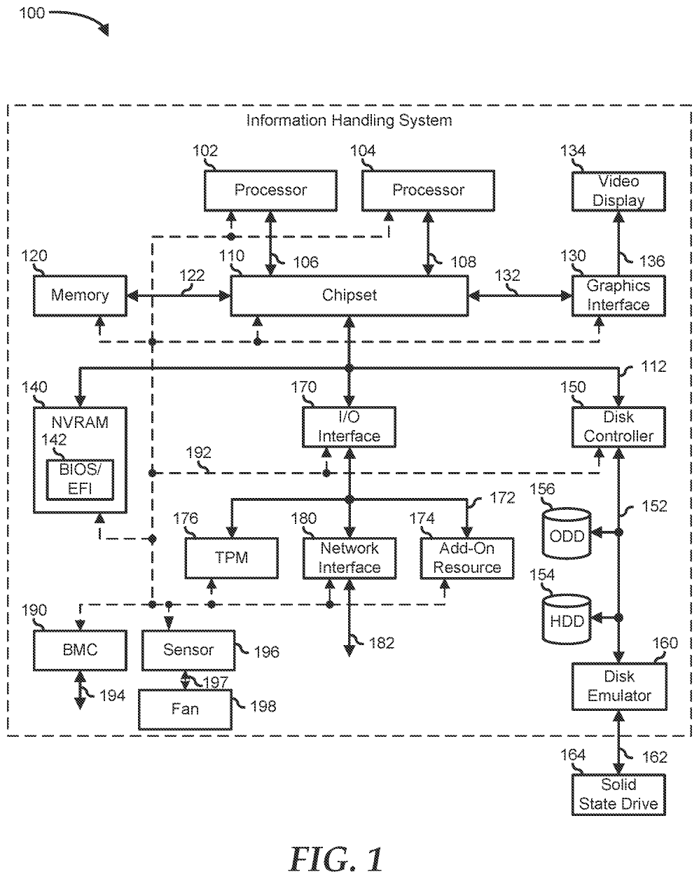

FIG. 1 illustrates an embodiment of an information handling system 100 including processors 102 and 104, a chipset 110, a memory 120, a graphics adapter 130 connected to a video display 134, a non-volatile RAM (NV-RAM) 140 that includes a basic input and output system/extensible firmware interface (BIOS/EFI) module 142, a disk controller 150, a hard disk drive (HDD) 154, an optical disk drive 156, a disk emulator 160 connected to a solid-state drive (SSD) 164, an input/output (I/O) interface 170 connected to an add-on resource 174 and a trusted platform module (TPM) 176, a network interface 180, a baseboard management controller (BMC) 190, a sensor 196, and a fan 198. Sensor 196 is connected to fan 198 via an interface 197. Processor 102 is connected to chipset 110 via processor interface 106, and processor 104 is connected to the chipset via processor interface 108. In a particular embodiment, processors 102 and 104 are connected together via a high-capacity coherent fabric, such as a HyperTransport link, a QuickPath Interconnect, or the like. Chipset 110 represents an integrated circuit or group of integrated circuits that manage the data flow between processors 102 and 104 and the other elements of information handling system 100. In a particular embodiment, chipset 110 represents a pair of integrated circuits, such as a northbridge component and a southbridge component. In another embodiment, some or all of the functions and features of chipset 110 are integrated with one or more of processors 102 and 104.

Memory 120 is connected to chipset 110 via a memory interface 122. An example of memory interface 122 includes a Double Data Rate (DDR) memory channel and memory 120 represents one or more DDR Dual In-Line Memory Modules (DIMMs). In a particular embodiment, memory interface 122 represents two or more DDR channels. In another embodiment, one or more of processors 102 and 104 include a memory interface that provides a dedicated memory for the processors. A DDR channel and the connected DDR DIMMs can be in accordance with a particular DDR standard, such as a DDR3 standard, a DDR4 standard, a DDR5 standard, or the like.

Memory 120 may further represent various combinations of memory types, such as Dynamic Random Access Memory (DRAM) DIMMs, Static Random Access Memory (SRAM) DIMMs, non-volatile DIMMs (NV-DIMMs), storage class memory devices, Read-Only Memory (ROM) devices, or the like. Graphics adapter 130 is connected to chipset 110 via a graphics interface 132 and provides a video display output 136 to a video display 134. An example of a graphics interface 132 includes a Peripheral Component Interconnect-Express (PCIe) interface and graphics adapter 130 can include a four-lane (×4) PCIe adapter, an eight-lane (×8) PCIe adapter, a 16-lane (×16) PCIe adapter, or another configuration, as needed or desired. In a particular embodiment, graphics adapter 130 is provided down on a system printed circuit board (PCB). Video display output 136 can include a Digital Video Interface (DVI), a High-Definition Multimedia Interface (HDMI), a DisplayPort interface, or the like, and video display 134 can include a monitor, a smart television, an embedded display such as a laptop computer display, or the like.

NV-RAM 140, disk controller 150, and I/O interface 170 are connected to chipset 110 via an I/O channel 112. An example of I/O channel 112 includes one or more point-to-point PCIe links between chipset 110 and each of NV-RAM 140, disk controller 150, and I/O interface 170. Chipset 110 can also include one or more other I/O interfaces, including a PCIe interface, an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. NV-RAM 140 includes BIOS/EFI module 142 that stores machine-executable code (BIOS/EFI code) that operates to detect the resources of information handling system 100, to provide drivers for the resources, to initialize the resources, and to provide common access mechanisms for the resources. The functions and features of BIOS/EFI module 142 will be further described below.

Disk controller 150 includes a disk interface 152 that connects the disc controller to a hard disk drive (HDD) 154, to an optical disk drive (ODD) 156, and to disk emulator 160. An example of disk interface 152 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 160 permits SSD 164 to be connected to information handling system 100 via an external interface 162. An example of external interface 162 includes a USB interface, an institute of electrical and electronics engineers (IEEE) 1394 (Firewire) interface, a proprietary interface, or a combination thereof. Alternatively, SSD 164 can be disposed within information handling system 100.

I/O interface 170 includes a peripheral interface 172 that connects the I/O interface to add-on resource 174, to TPM 176, and to network interface 180. Peripheral interface 172 can be the same type of interface as I/O channel 112 or can be a different type of interface. As such, I/O interface 170 extends the capacity of I/O channel 112 when peripheral interface 172 and the I/O channel are of the same type, and the I/O interface translates information from a format suitable to the I/O channel to a format suitable to the peripheral interface 172 when they are of a different type. Add-on resource 174 can include a data storage system, an additional graphics interface, a network interface card (NIC), a sound/video processing card, another add-on resource, or a combination thereof. Add-on resource 174 can be on a main circuit board, on separate circuit board, or add-in card disposed within information handling system 100, a device that is external to the information handling system, or a combination thereof.

Network interface 180 represents a network communication device disposed within information handling system 100, on a main circuit board of the information handling system, integrated onto another component such as chipset 110, in another suitable location, or a combination thereof. Network interface 180 includes a network channel 182 that provides an interface to devices that are external to information handling system 100. In a particular embodiment, network channel 182 is of a different type than peripheral interface 172, and network interface 180 translates information from a format suitable to the peripheral channel to a format suitable to external devices.

In a particular embodiment, network interface 180 includes a NIC or host bus adapter (HBA), and an example of network channel 182 includes an InfiniBand channel, a Fibre Channel, a Gigabit Ethernet channel, a proprietary channel architecture, or a combination thereof. In another embodiment, network interface 180 includes a wireless communication interface, and network channel 182 includes a Wi-Fi channel, a near-field communication (NFC) channel, a Bluetooth® or Bluetooth-Low-Energy (BLE) channel, a cellular based interface such as a Global System for Mobile (GSM) interface, a Code-Division Multiple Access (CDMA) interface, a Universal Mobile Telecommunications System (UMTS) interface, a Long-Term Evolution (LTE) interface, or another cellular based interface, or a combination thereof. Network channel 182 can be connected to an external network resource (not illustrated). The network resource can include another information handling system, a data storage system, another network, a grid management system, another suitable resource, or a combination thereof.

BMC 190 is connected to multiple elements of information handling system 100 via one or more management interface 192 to provide out of band monitoring, maintenance, and control of the elements of the information handling system. As such, BMC 190 represents a processing device different from processor 102 and processor 104, which provides various management functions for information handling system 100. For example, BMC 190 may be responsible for power management, cooling management, and the like. The term BMC is often used in the context of server systems, while in a consumer-level device, a BMC may be referred to as an embedded controller (EC). A BMC included in a data storage system can be referred to as a storage enclosure processor. A BMC included at a chassis of a blade server can be referred to as a chassis management controller and embedded controllers included at the blades of the blade server can be referred to as blade management controllers. Capabilities and functions provided by BMC 190 can vary considerably based on the type of information handling system. BMC 190 can operate in accordance with an Intelligent Platform Management Interface (IPMI). Examples of BMC 190 include an Integrated Dell® Remote Access Controller (iDRAC).

Management interface 192 represents one or more out-of-band communication interfaces between BMC 190 and the elements of information handling system 100, and can include an I²C bus, a System Management Bus (SMBus), a Power Management Bus (PMBUS), a Low Pin Count (LPC) interface, a serial bus such as a Universal Serial Bus (USB) or a Serial Peripheral Interface (SPI), a network interface such as an Ethernet interface, a high-speed serial data link such as a PCIe interface, a Network Controller Sideband Interface (NC-SI), or the like. As used herein, out-of-band access refers to operations performed apart from a BIOS/operating system execution environment on information handling system 100, that is apart from the execution of code by processors 102 and 104 and procedures that are implemented on the information handling system in response to the executed code.

BMC 190 operates to monitor and maintain system firmware, such as code stored in BIOS/EFI module 142, option ROMs for graphics adapter 130, disk controller 150, add-on resource 174, network interface 180, sensor 196, fan 198, or other elements of information handling system 100, as needed or desired. In particular, BMC 190 includes a network interface 194 that can be connected to a remote management system to receive firmware updates, as needed or desired. Here, BMC 190 receives the firmware updates, stores the updates to a data storage device associated with the BMC, transfers the firmware updates to NV-RAM of the device or system that is the subject of the firmware update, thereby replacing the currently operating firmware associated with the device or system, and reboots information handling system, whereupon the device or system utilizes the updated firmware image.

BMC 190 utilizes various protocols and application programming interfaces (APIs) to direct and control the processes for monitoring and maintaining the system firmware. An example of a protocol or API for monitoring and maintaining the system firmware includes a graphical user interface (GUI) associated with BMC 190, an interface defined by the Distributed Management Taskforce (DMTF) (such as a Web Services Management (WSMan) interface, a Management Component Transport Protocol (MCTP) or, a Redfish® interface), various vendor defined interfaces (such as a Dell EMC Remote Access Controller Administrator (RACADM) utility, a Dell EMC OpenManage Enterprise, a Dell EMC OpenManage Server Administrator (OMSS) utility, a Dell EMC OpenManage Storage Services (OMSS) utility, or a Dell EMC OpenManage Deployment Toolkit (DTK) suite), a BIOS setup utility such as invoked by a “F2” boot option, or another protocol or API, as needed or desired.

In a particular embodiment, BMC 190 is included on a main circuit board (such as a baseboard, a motherboard, or any combination thereof) of information handling system 100 or is integrated onto another element of the information handling system such as chipset 110, or another suitable element, as needed or desired. As such, BMC 190 can be part of an integrated circuit or a chipset within information handling system 100. An example of BMC 190 includes an iDRAC, or the like. BMC 190 may operate on a separate power plane from other resources in information handling system 100. Thus BMC 190 can communicate with the management system via network interface 194 while the resources of information handling system 100 are powered off. Here, information can be sent from the management system to BMC 190 and the information can be stored in a RAM or NV-RAM associated with the BMC. Information stored in the RAM may be lost after power-down of the power plane for BMC 190, while information stored in the NV-RAM may be saved through a power-down/power-up cycle of the power plane for the BMC.

Information handling system 100 can include additional components and additional busses, not shown for clarity. For example, information handling system 100 can include multiple processor cores, audio devices, and the like. While a particular arrangement of bus technologies and interconnections is illustrated for the purpose of example, one of skill will appreciate that the techniques disclosed herein are applicable to other system architectures. Information handling system 100 can include multiple central processing units (CPUs) and redundant bus controllers. One or more components can be integrated together. Information handling system 100 can include additional buses and bus protocols, for example, I²C and the like. Additional components of information handling system 100 can include one or more storage devices that can store machine-executable code, one or more communications ports for communicating with external devices, and various input and output (I/O) devices, such as a keyboard, a mouse, and a video display.

For purposes of this disclosure information handling system 100 can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 100 can be a personal computer, a laptop computer, a smartphone, a tablet device or other consumer electronic device, a network server, a network storage device, a switch, a router, or another network communication device, or any other suitable device and may vary in size, shape, performance, functionality, and price. Further, information handling system 100 can include processing resources for executing machine-executable code, such as processor 102, a programmable logic array (PLA), an embedded device such as a System-on-a-Chip (SoC), or other control logic hardware. Information handling system 100 can also include one or more computer-readable media for storing machine-executable code, such as software or data.

Systems that may include fans, blowers, and liquid circulation are provided to cool information handling systems and their components. Such systems typically use specific thresholds to regulate a cooling system. For example, specific revolutions per minute (RPM) thresholds are typically used to adjust cooling fan speeds and reduce or eliminate fan noise. However limiting adjusting cooling fan speeds to RPM thresholds does not take into account other factors, also referred to as inputs, such as user intention and preference. To address this and other concerns, the present disclosure considers the aforementioned factors among others in adjusting cooling fan speeds to cool the information handling system. The present disclosure may also use the aforementioned factors to also determine the CPU allocation of tasks or processes that are currently running in the foreground and/or the background.

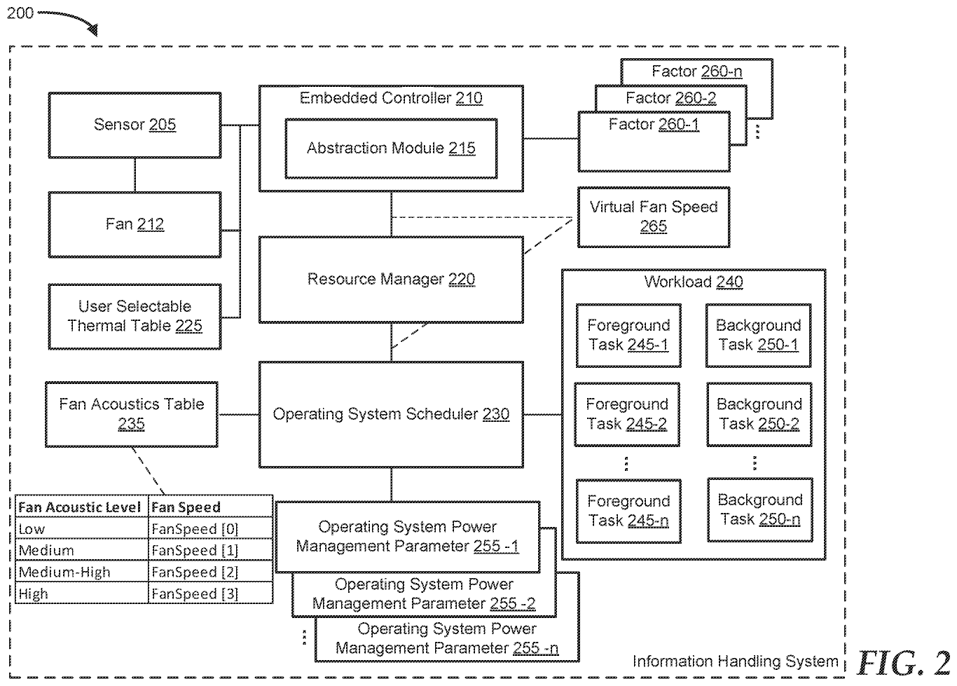

FIG. 2 illustrates an information handling system 200 for dynamic fan speed manipulation to influence the allocation of computing resources. Information handling system 200, which is similar to information handling system 100 of FIG. 1, includes a sensor 205, a embedded controller 210, a fan 212, a resource manager 220, a user selectable thermal table 225, an operating system scheduler 230, a fan acoustics table 235, and a workload 240. The components of information handling system 200 may be implemented in hardware, software, firmware, or any combination thereof. The components shown are not drawn to scale and information handling system 200 may include additional or fewer components. In addition, connections between components may be omitted for descriptive clarity. In various embodiments, information handling system 200 may not include each of the components shown in FIG. 2. Additionally, or alternatively, information handling system 200 may include various additional components in addition to those that are shown in FIG. 2. Furthermore, some components that are represented as separate components in FIG. 2 may in certain embodiments instead are integrated with other components. For example, in certain embodiments, all or a portion of the functionality provided by the illustrated components may instead be provided by components integrated into one or more processor(s) as a system-on-a-chip.

Information handling system 200 may include a cooling system that is designed to provide sufficient cooling for system components under various conditions. For example, a user who places a greater load on system components might require greater cooling capabilities than a user who places a lesser load on system components. In another example, one user may place a computer in an enclosed location where there is little external airflow, such as next to a wall. Another person may place a computer in an open location with substantial external airflow, such as in the middle of an open room. A user who uses a computer in a warm location would have different cooling requirements from a user who uses a computer in a cooler location. Further, environmental and use conditions that affect cooling system demand may change over time with the changing of the seasons or changing of a user's demands on the system. These differences in conditions among others may factor into how the cooling system dynamically manipulates the fan speed APIs to influence the allocation of the computing resources. For example, the present disclosure accounts for various factors in cooling information handling system 200, such as ambient temperature, usage history, user preference, system state, cooling fan speed, system context, user context, platform thermal information, platform thermal mode, platform characteristics, etc.

Embedded controller 210, which is similar to BMC 190 of FIG. 1, may be configured to provide out-of-band management facilitates or management of information handling system 200. Such management may be made by embedded controller 210 even if information handling system 200 is powered off or powered to a standby state. Embedded controller 210 may include a processor, memory, and out-of-band network interface separate from and physically isolated from an in-band network interface of information handling system 200 and/or other embedded information handling resources. In certain embodiments, embedded controller 210 may include or may be an integral part of a BMC, management controller, service processor, or a remote access controller. In other embodiments, embedded controller 210 may include or may be an integral part of an enclosure controller.

Embedded controller 210 includes an abstraction module 215 which may interface with a fan speed API to manipulate desired performance and power efficiency settings of information handling system 200 in alignment with the user's intent. In particular, abstraction module 215 may be configured to determine a virtual fan speed 265, also referred to as abstract fan speed, which may be used to influence workload 240. Virtual fan speed 265 may be an abstraction of a current fan speed of one or more cooling fans in information handling system 200. If there is more than one fan included in information handling system 200, then abstraction module 215 may aggregate the current speed of the fans. Abstraction module 215 may also take the average or median of the current fan speeds.

Virtual fan speed 265 may be abstracted or derived based on several factors, such as factors 260-1 through 260-n. Factors 260 may include factors system context, user context, current system state, user preference setting, user intent, platform thermal information, platform thermal mode, platform characteristics, etc., such as factors depicted above. Factors 260 may be ranked amongst each other, and a weight associated with each factor according to its ranking. For example, the higher the ranking of one factor in comparison to other factors, the greater the weight assigned to it. The ranking may be based on the impact of the factor in determining virtual fan speed 265 and may be pre-determined by the user or administrator prior to the abstraction of the current fan speed. For example, the fan speed, platform state, and/or the user intent may be assigned a higher weight by abstraction module 215 compared to the platform characteristics. Abstraction module 215 may transmit virtual fan speed 265 to resource manager 220 via API.

The system context can include information associated with a system mode of information handling system 200, such as whether information handling system 200 is in a tablet mode, a clamshell mode, a tent mode, etc. The user context can include information associated with information handling system 200 relative to the user, such as whether information handling system 200 is on top of a desk or the user's lap. The system power state can include information associated with a current state of information handling system 200, such as whether information handling system 200 is in a working state, sleep state, hibernate state, etc. The platform thermal information can include a current temperature of information handling system 200. The platform thermal information can also include temperature reported by various sensors of information handling system 200, such as skin temperature, temperature of specific components, etc. The thermal mode can include a thermal mode selected by the user and as depicted in user selectable thermal table 225.

User-selectable thermal table 225 may include a range of values associated with the thermal mode of information handling system 200, wherein the values may be selectable by a user. For example, during a system set up prior to booting to an operating system, the user can select a thermal mode based on the ranges in user-selectable thermal table 225. The thermal mode selected may be used to provide the user's intent as an input in abstracting the current fan speed of fan 212. This allows the user to choose how information handling system 200 should optimally react and/or how the user intends to use information handling system 200. User-selectable thermal table 225 may include several thermal modes, such as cool, quiet, optimized, and ultra performance. The “cool” thermal mode may imply that the fan speed and/or acoustic level is not a concern for the user. The “quiet” thermal mode may imply that the speed of the cooling fan speed is a concern of the user. The “optimized” thermal mode may imply that the default settings, such as default factory settings, may be implemented. The “ultra performance” thermal mode may imply that the performance of information handling system 200 is a concern for the user but not the fan speed. One of skill in the art will appreciate that other cooling thermal modes may be used in addition to or in lieu of the aforementioned thermal modes.

Sensor 205 may be a temperature sensing device such as a thermocouple, a resistance temperature detector, a thermistor, an integrated circuit, or another suitable device. Sensor 205 can be used to determine a temperature of an associated device or devices. The temperature may be provided to embedded controller 210 which can be used by abstraction module 215 as one of factors 260. Fan 212, also referred to herein as a cooling fan, may be configured for cooling one or more components of information handling system 200. Current fan speed, also referred to as actual fan speed, values in RPM may also be provided to embedded controller 210 which may be abstracted by abstraction module 215.

Resource manager 220 may be configured to manage system resources, such as hardware and software resources. As part of managing these resources, resource manager 220 may be configured to receive virtual fan speed 265 from abstraction module 215. In one embodiment, virtual fan speed 265 may be in a value in RPM and may be associated with an index for a fan speed column in fan acoustics table 235. The fan speed index may be mapped to a particular range of RPMs, such as inclusive of a lower and upper fan speed threshold. For example, fanSpeed [0] may be mapped to a fan speed value of 1,000 to 4,000 RPM, while fanSpeed [1] may be mapped to a fan speed value of 4,001 to 5,000 RPM, and so on. Accordingly, the fan speed index may be mapped to a different range of fan speed values.

Virtual fan speed 265 may be used in managing the hardware and software resources. For example, virtual fan speed 265 may be transmitted by resource manager 220 to operating system scheduler 230 via an API. Based on virtual fan speed 265, operating system scheduler 230 may determine the associated fan acoustic level according to fan acoustics table 235. Because virtual fan speed 265 may be an abstraction of the current fan speed of fan 212, virtual fan speed 265 may be equal to or different from the current fan speed. For example, virtual fan speed 265 may be greater than, equal to, or less than the current fan speed of fan 212.

Fan acoustics table 235 includes a mapping of cooling fan acoustic levels to a range of fan speed thresholds. Each row in fan acoustics table 235 may have a fan acoustics level associated with a fan speed threshold. For example, a first fan acoustic level is associated with a fan speed at or below a first fan speed threshold. A second fan acoustic level is associated with a fan speed above the first fan speed threshold but below a second fan speed threshold, and so on. For example, a virtual fan speed of 1,000 to 4,000 RPM may be mapped to a low fan acoustic level. At this fan speed, the acoustic or noise level of the fan may be at or below a particular threshold, such as 25 decibels. A virtual fan speed of 4,001 to 5,000 RPM may be mapped to a medium fan acoustic level, as the noise level of the fan at this speed may be greater than 25 decibels, and so on. The fan speed thresholds may be pre-determined criteria and may vary from one fan to another. The fan acoustic levels may be used to influence the scheduling of the current workload. The fan acoustic level may include low, medium, medium-high, and high. Fan acoustics table 235 shown herein is an illustration to provide an example. One of skill in the art will appreciate that different values for the fan acoustic levels may be used. For example, a range of numerical values may be used, such as zero, one, two, three, etc.

Workload 240 includes tasks currently running in the foreground and/or the background, such as foreground tasks 245-1 through 245-n and background tasks 250-1 through 250-n. Foreground tasks 245 may, by default, be given priority over background tasks 250-1 through 250-n. Operating system scheduler 230 may manage workload 240 based on a fan acoustic level that virtual fan speed 265 is mapped to. Operating system scheduler 230 may perform one or more actions in managing workload 240 by using operating system power management parameters (OSPM) 255-1 through 255-n, such as via fan speed APIs. The action may also be performed using one or more of OSPM parameters 255, such as by controlling the processor operating frequency or voltage of a processor.

In addition, operating system scheduler 230 and/or resource manager 220 may also allocate or deallocate computing resources to workload 240 based on one or more policies and/or rules, thereby controlling the background and/or service tasks. By managing workload 240, operating system scheduler 230 and/or resource manager 220 may regulate thermal and acoustic levels of information handling system 200. In one embodiment, operating system scheduler 230 and/or resource manager 220 may lower the priority of one or more background tasks 250 so that operating system scheduler 230 may not schedule the background tasks until their priority is restored. Resource manager 220 and/or operating system schedule may restore the priority of the background tasks when the fan acoustic level is at a desired level. The priority of the background tasks may also be restored when information handling system 200 is idle or at least not in a busy state.

For example, if the fan acoustic level is “low”, then operating system scheduler 230 and/or resource manager 220 may not alter the state background tasks 250. If the fan acoustic level is “medium”, then operating system scheduler 230 and/or resource manager 220 may perform a minor reduction of background tasks 250. For example, operating system scheduler 230 may delay a non-essential background task. If the fan acoustic level is “medium-high” may perform a reduction of background tasks 250. For example, operating system scheduler 230 and/or resource manager 220 may stop a non-essential background task. Operating system scheduler and/or resource manager 220 may resume the non-essential task when the fan acoustic level reverts to the low fan acoustic level. If the fan acoustic level is “high”, then operating system scheduler 230 and/or resource manager 220 may throttle background tasks 250. With the throttling of the background tasks, the fan's acoustic level may be reduced. Thus, background tasks 250 may be resumed when the fan acoustic level changes to low.

The term task used in the present disclosure may refer to a thread or process currently being executed in the foreground or background. The term process and thread may be used interchangeably to refer to a sequence of processor-executable instructions that can be managed independently by operating system scheduler 230, resource manager 220, or another type of scheduler that is managed by operating system scheduler 230.

As used herein, a hyphenated form of a reference numeral refers to a specific instance of an element and the un-hyphenated form of the reference numeral refers to the collective or generic element. Thus, for example, factor “260-1” refers to an instance of a factor class, which may be referred to collectively as factors “260” and any of which may be referred to generically as a factor “260”.

Those of ordinary skill in the art will appreciate that the configuration, hardware, and/or software components of information handling system 200 depicted in FIG. 2 may vary. For example, the illustrative components within information handling system 200 are not intended to be exhaustive, but rather are representative to highlight components that can be utilized to implement aspects of the present disclosure. For example, other devices and/or components may be used in addition to or in place of the devices/components depicted. The depicted example does not convey or imply any architectural or other limitations with respect to the presently described embodiments and/or the general disclosure. In the discussion of the figures, reference may also be made to components illustrated in other figures for the continuity of the description.

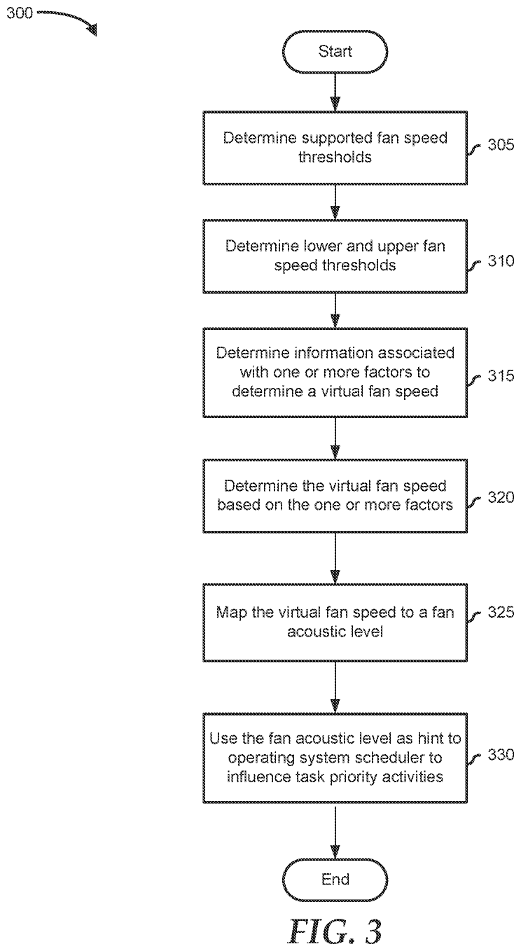

FIG. 3 is a flowchart illustrating a method 300 for dynamic fan speed manipulation to influence computing resources. Method 300 may be performed by one or more components of information handling system 200 of FIG. 2, such as abstraction module 215, resource manager 220, and/or operating system scheduler 230. However, while embodiments of the present disclosure are described in terms of information handling system 200 of FIG. 2, it should be recognized that other systems may be utilized to perform the described method. One of skill in the art will appreciate that this flowchart explains a typical example, which can be extended to advanced applications or services in practice.

Method 300 typically starts at block 305 where the method determines one or more fan speed thresholds or limits. For example, the abstraction module may get supported fan speed thresholds of a cooling fan, from an ACPI table. The fan speed thresholds may be used to influence the performance, thermals, and/or acoustics of the information handling system. The method may also determine the supported granularity of the fan speed.

At block 310, the method may determine upper and/or lower fan speed thresholds and associated policy. The abstraction module and/or the operating system may determine one or more fan speed thresholds as multiples of the supported granularity. For example, a lower threshold of one RPM and an upper threshold of 4,000 RPM may be mapped to a first fan speed threshold. A second fan speed threshold may have a lower threshold of 4,001 RPM and an upper threshold of 5,000 RPM. A third fan speed threshold may have a lower threshold of 5,001 RPM and an upper threshold of 6,000 RPM. A fourth fan speed threshold may have a threshold of 6,001 RPM or more.

At block 315, the method may collect and/or receive information associated with one or more factors to determine a virtual fan speed. The factors may have been pre-determined and include user intent, surface temperature, system state, etc. The user intent may be implied based on a setting selected by the user during the system setup, wherein the setting may be reflected in a value selected in a user-selectable thermal table. For example, if the user selects the quiet thermal mode, this may imply that the user does not want the fan to be turned on as the user does not want any acoustics while using the information handling system. In another example, if the user selects the ultraperformance mode, this may imply that the performance of the information handling system may be more important than fan acoustic levels.

At block 320, the method may determine a virtual fan speed based on the current fan speed in consideration of one or more factors. In one embodiment, a weight may be assigned to each factor based on a pre-determined rank or relative importance of each of the factors. For example, a higher weight may be assigned to the user's intent than the surface temperature of the information handling system. In addition, the current fan speed may be given the same weight as the user's intent. For example, if the user intent is to keep the fan acoustics low or quiet, then the resource manager may adjust the current fan speed value, such as from 2,500 RPM to a virtual fan speed value of 3,000 RPM. In another example, if the user intent is to maximize the performance of the information handling system, then the resource manager may also adjust the current fan speed value, such as from 2,500 to a virtual fan speed value of 2,000 RPM. This method, in particular, may transmit the virtual fan speed to the operating system scheduler. Receipt of the virtual fan speed can trigger the operating system scheduler to adjust the operation of one or more background tasks. In another embodiment, the resource manager may not transmit the virtual fan speed so as not to trigger the operating system scheduler into performing an action.

At block 325, the method may map the virtual fan speed to a fan acoustic level. In one embodiment, the resource manager and/or operating system scheduler may use a fan acoustics table to determine the fan acoustic level associated with the virtual fan speed. The method may proceed to block 330, where an action associated with a policy related to managing thermal, performance, power, and acoustics may be performed. In particular, the operating system scheduler and/or the resource manager may perform an action based on the fan acoustic level using one or more OSPM parameters. The action may be in accordance with a fan acoustic policy, which may be based on a fan acoustic level. OSPM parameter(s) may be used to adjust power settings on the background and/or foreground processes, such as based on the priority level of the background and/or foreground processes according to the policy. For example, the operating system scheduler may stop, restrict, or delay one or more of the background and/or service tasks. The operating system scheduler may also throttle one or more of the background or service tasks.

Although FIG. 3 shows example blocks of method 300 in some implementations, method 300 may include additional blocks, fewer blocks, different blocks, or differently arranged blocks than those depicted in FIG. 3. Those skilled in the art will understand that the principles presented herein may be implemented in any suitably arranged processing system. Additionally, or alternatively, two or more of the blocks of method 300 may be performed in parallel. For example, blocks 310 and 315 of method 300 may be performed in parallel.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

When referred to as a “device,” a “module,” a “unit,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded in a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device).

The present disclosure contemplates a computer-readable medium that includes instructions or receives and executes instructions responsive to a propagated signal; so that a device connected to a network can communicate voice, video, or data over the network. Further, the instructions may be transmitted or received over the network via the network interface device.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes, or another storage device to store information received via carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents but also equivalent structures.

What is claimed is:

1. A method comprising:
determining, by a processor, a fan speed value based on a current fan speed value and at least one factor;
transmitting the fan speed value instead of the current fan speed value to an operating system scheduler;
determining a fan acoustic level based on the fan speed value; and
performing, by the operating system scheduler, an action based on the fan acoustic level.

2. The method of claim 1, further comprising associating a weight to the at least one factor.

3. The method of claim 2, wherein the weight is based on a rank of the factor.

4. The method of claim 1, further comprising in response to determining another current fan speed value that is associated with another fan, aggregating the current fan speed value and the another current fan speed value.

5. The method of claim 1, wherein the at least one factor includes user intent.

6. The method of claim 1, wherein the at least one factor includes system state.

7. The method of claim 1, wherein the at least one factor includes thermal mode.

8. The method of claim 1, wherein the action is performed via an application programming interface.

9. The method of claim 1, wherein the action includes adjusting a priority of a background task.

10. The method of claim 9, wherein adjusting the priority of the background task includes lowering the priority of the background task.

11. The method of claim 10, further comprising subsequent to lowering the priority of the background task, restoring the priority of the background task in response to a change in the fan acoustic level.

12. An information handling system, comprising:
a processor; and
a memory storing code that when executed causes the processor to perform operations including:
determining a fan speed value based on a current fan speed value and at least one factor;
transmitting the fan speed value instead of the current fan speed value to an operating system scheduler;
determining a fan acoustic level based on the fan speed value; and
performing, by the operating system scheduler, an action based on the fan acoustic level.

13. The information handling system of claim 12, wherein the operations further comprise associating a weight to the at least one factor.

14. The information handling system of claim 13, wherein the weight is based on a rank of the factor.

15. The information handling system of claim 12, wherein the operations further comprise in response to determining another current fan speed value that is associated with another fan, aggregating the current fan speed value and the another current fan speed value.

16. The information handling system of claim 12, wherein the at least one factor includes user intent.

17. The information handling system of claim 12, wherein the at least one factor includes system state.

18. A non-transitory computer-readable medium to store instructions that are executable to perform operations comprising:
determining a fan speed value based on a current fan speed value and at least one factor;
transmitting the fan speed value instead of the current fan speed value to an operating system scheduler;
determining a fan acoustic level based on the fan speed value; and
performing, by the operating system scheduler, an action based on the fan acoustic level.

19. The non-transitory computer-readable medium of claim 18, wherein the operations further comprise in response to determining another current fan speed value that is associated with another fan, aggregating the current fan speed value and the another current fan speed value.

20. The non-transitory computer-readable medium of claim 18, wherein the at least one factor includes thermal mode.
